(19) United States
(12) Patent Application Publication
(10) Pub. No.: US 2022/0034921 A1
(43) Pub. Date: Feb. 3, 2022

(54) METHOD AND SYSTEM FOR SEARCHING FOR SYNTHESIS CONDITION

(71) Applicant: Samsung Electronics Co., Ltd., Suwon-si (KR)

(72) Inventors: Keechang Lee, Seoul (KR); Yoonseok Ko, Suwon-si (KR); Sangsoo Jee, Hwaseong-si (KR)

(21) Appl. No.: 17/387,130

(22) Filed: Jul. 28, 2021

(30) Foreign Application Priority Data
Jul. 29, 2020 (KR) 10-2020-0094796

(51) Int. Cl. G01N 35/00

(52) U.S. Cl. CPC G01N 35/00584

(57) ABSTRACT

A method of searching for a synthesis condition includes: designating N+1 vertices separated from each other, each having an experimental condition corresponding to a designated location in an N-dimensional space including N axes, each corresponding to a different experimental variable; performing a reflection operation for moving the first vertex determined based on experimental values corresponding to the vertices to an opposite side of an N−1 dimensional simplex based on a center point of the N−1 dimensional simplex corresponding to remaining N vertices; performing a projection operation for moving again the first vertex back to a location where a movement path of the first vertex and a predetermined boundary of the N-dimensional space cross each other when the first vertex is moved outside the predetermined boundary; and determining, as the synthesis condition, an experimental condition of a final vertex determined based on experimental values corresponding to vertices after the projection operation.

### CROSS-REFERENCE TO RELATED APPLICATION

This application claims priority to Korean Patent Application No. 10-2020-0094796, filed on Jul. 29, 2020, and all the benefits accruing therefrom under 35 U.S.C. § 119, the content of which in its entirety is herein incorporated by reference.

### BACKGROUND

### 1. Field

The disclosure relates to methods and systems for searching for a synthesis condition.

### 2. Description of Related Art

In a method for searching for optimal synthesis conditions, in which multiple experiments are planned in advance through design of experiments (“DOE”), the experiments are typically performed in a batch, and afterwards, the results are analyzed has been used. In such a method, in general, a large number of experiments may be performed, and the number of required experiments may increase with an increase in the range and number of experiment variables. Also, experimental results may be obtained after all planned experiments are completed, and intermediate experimental results may not be used until all the experiments are completed.

Accordingly, in searching for synthesis conditions, a technique for accurately searching for optimal synthesis conditions while reducing the number of experiments by using intermediate experimental results, etc. may be desired.

### SUMMARY

Embodiments are directed to methods and systems for searching a synthesis condition. Embodiments are directed to computer-readable recording media having recorded thereon a computer program for executing the methods.

According to an embodiment of the invention, a method of searching for a synthesis condition includes: designating N+1 vertices separated from each other in an N-dimensional space including N axes, each corresponding to a different experimental variable, wherein each of the N+1 vertices has an experimental condition corresponding to a designated location in the N-dimensional space , and N is a natural number; performing a reflection operation for moving the first vertex determined based on experimental values corresponding to the N+1 vertices to an opposite side of an N−1 dimensional simplex based on a center point of the N−1 dimensional simplex corresponding to remaining N vertices; performing a projection operation for moving again the first vertex back to a location where a movement path of the first vertex and a predetermined boundary of the N-dimensional space cross when the first vertex is moved outside the predetermined boundary of the N-dimensional space; and determining an experimental condition of a final vertex determined based on experimental values corresponding to vertices after the projection operation as the synthesis condition.

According to an embodiment of the invention, a synthesis condition searching system includes: a controller which designates N+1 vertices separated from each other in an N-dimensional space including N axes, each corresponding to a different experimental variable, where each of the N+1 vertices has an experimental condition corresponding to a designated location in the N-dimensional space, and N is a natural number; an experiment unit which outputs experimental values corresponding to the N+1 vertices; and a search unit which determines a first vertex based on the experimental values, and moves the first vertex to an opposite side of an N−1 dimensional simplex based on a center point of the N−1 dimensional simplex corresponding to remaining N vertices, where the each unit moves the first vertex to a location where a movement path of the first vertex and a predetermined boundary cross of the N-dimensional space when the first vertex is moved outside the predetermined boundary of the N-dimensional space, and the controller determines a final vertex based on experimental values corresponding to the vertices after the first vertex is moved again, and determines an experimental condition of the final vertex as the synthesis condition.

According to an embodiment of the invention, a recording medium includes a non-transitory computer-readable recording medium having recorded thereon a computer program for executing the method described above.

### BRIEF DESCRIPTION OF THE DRAWINGS

The above and other features of embodiments of the disclosure will be more apparent from the following description taken in conjunction with the accompanying drawings, in which:

FIG. 1 is a block diagram of a system for searching for a synthesis condition according to an embodiment;

FIGS. 2A to 2C are diagrams showing a method of searching for a synthesis condition according to an embodiment;

FIG. 3 is a diagram for explaining a method of performing a projection according to an embodiment;

FIGS. 4A and 4B are diagrams showing a method of reducing a dimension of an N-dimensional space according to an embodiment;

FIGS. 5A and 5B are diagrams showing a result of reducing a dimension of an N-dimensional space according to an embodiment;

FIGS. 6A and 6B are diagrams showing a method of reducing a dimension of an N-dimensional space according to an alternative embodiment;

FIG. 7 is a diagram showing a result of reducing a dimension of an N-dimensional space according to an alternative embodiment;

FIG. 8 is a flowchart of a method of searching for a synthesis condition according to an embodiment;

FIG. 9 is a flowchart of a method of searching for a synthesis condition according to an alternative embodiment;

FIG. 10 is a diagram showing synthesis condition search results according to various embodiments;

FIGS. 11A to 11C are diagrams illustrating an N-dimensional space according to the experiment of FIG. 10;

FIG. 12 is a diagram showing an embodiment in which vertices are designated for each of a plurality of regions;

FIG. 13 is a flowchart of a method of searching for a synthesis condition according to the embodiment of FIG. 12;

FIG. 14 is a diagram showing another alternative embodiment in which vertices are designated in each of a plurality of regions; and

FIG. 15 is a flowchart of a method of searching for a synthesis condition according to the embodiment of FIG. 14.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

Terminologies used herein are selected as commonly used by those of ordinary skill in the art in consideration of functions of the current embodiment, but may vary according to the technical intention, precedents, or a disclosure of a new technology. Also, in particular cases, some terms are arbitrarily selected by the applicant, and in this case, the meanings of the terms will be described in detail at corresponding parts of the specification. Accordingly, the terms used in the specification should be defined not by simply the names of the terms but based on the meaning and contents of the whole specification.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, embodiments of the invention will be described in detail with reference to the accompanying drawings.

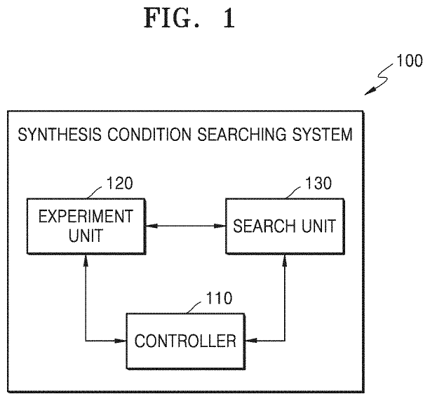

FIG. 1 is a block diagram of a synthesis condition searching system 100 according to an embodiment.

Referring to FIG. 1, an embodiment of the synthesis condition searching system 100 may include a controller 110, an experiment unit 120, and a search unit 130.

In the synthesis condition searching system 100 illustrated in FIG. 1, only elements related to the embodiment are shown. Therefore, it is obvious to those skilled in the art that the synthesis condition searching system 100 may further include other general-purpose components in addition to the components shown in FIG. 1.

An embodiment of the synthesis condition searching system 100 may determine values for calculating an optimal synthesis result with respect to a plurality of experimental variables used in a synthesis experiment of a substance. The substance may correspond to, for example, a compound or any element that may be synthesized. Among a plurality of experimental conditions including arbitrary values with respect to a plurality of experimental variables, an experimental condition including values for calculating an optimal synthesis result may correspond to the synthesis condition. An optimal synthesis result may correspond to, for example, the highest yield. The synthesis condition searching system 100 may search for a synthesis condition that is an optimal experimental condition among various experimental conditions.

In one embodiment, for example, when the experimental variables for synthesizing of a substance correspond to a synthesis time and a synthesis temperature, a condition including an arbitrary synthesis time and an arbitrary synthesis temperature may correspond to an experimental condition. The synthesis condition searching system 100 may determine a combination of a synthesis time and a synthesis temperature that yields an optimal synthesis result, and an optimal experimental condition including the combination of the determined synthesis time and the synthesis temperature may correspond to the synthesis condition.

The search unit 130 may perform an algorithm for determining a synthesis condition. In one embodiment, for example, the algorithm for determining a synthesis condition may be based on Nelder-Mead method or Nelder-Mead simplex algorithm (“a simplex method for function minimization”, Computer Journal, Volume 7, Issue 4, Jan. 1965, Pages 308-313). The search unit 130 may sequentially generate various experimental conditions to determine a synthesis condition. The search unit 130 may transmit the experimental conditions to the experiment unit 120 and generate new experimental conditions based on the experimental values output from the experiment unit 120. The search unit 130 may search for improved experimental conditions by repeating the process of generating new or updated experimental conditions based on experimental values, and as a result, search for an optimized synthesis condition.

The experiment unit 120 may perform an experiment of synthesizing a substance based on an experiment condition transmitted from the controller 110 or the search unit 130 and output an experiment value that is an experiment result. The experiment unit 120 may transmit the experiment value to the search unit 130, and then, may perform a synthesis experiment again based on the new or updated experiment condition newly transmitted from the search unit 130. The experiment unit 120 may include a synthesis unit that performs an experiment and a measurement unit that outputs an experiment value by measuring the synthesized material. The experiment unit 120 may automatically perform an experiment upon receiving an experiment condition. In one embodiment, for example, the experiment unit 120 may include an automated batch device or a flow chemistry device. In one embodiment, for example, the measurement unit may include in-line measuring equipment, such as high performance liquid chromatography (“HPLC”), infrared (“IR”) spectroscopy, ultraviolet (“UV”)-vis spectroscopy, mass spectrometry, etc. However, components that may be included in the experiment unit 120 are only examples, and are not limited thereto.

The controller 110 controls an overall operation of the synthesis condition searching system 100. The controller 110 controls operations of other components included in the synthesis condition searching system 100 in addition to the search unit 130 and the experiment unit 120. In addition, the controller 110 may determine whether the synthesis condition searching system 100 is in an operable state or not by checking the state of each of the components of the synthesis condition searching system 100.

The controller 110 may directly transmit an experimental condition to the experiment unit 120 or control the search unit 130 to transmit the experimental condition from the search unit 130 to the experiment unit 120. The controller 110 may receive the experiment value output from the experiment unit 120. The controller 110 may directly transmit the experiment value to the search unit 130 or control the experiment unit 120 to transmit the experiment value from the experiment unit 120 to the search unit 130. The controller 110 may determine a synthesis condition based on the received experiment value.

The controller 110 may include a processor. The processor may be implemented as an array of a plurality of logic gates, or may be implemented as a combination of a general-purpose microprocessor and a memory in which a program executable in the microprocessor is stored. Alternatively, the processor may be implemented with other types of hardware.

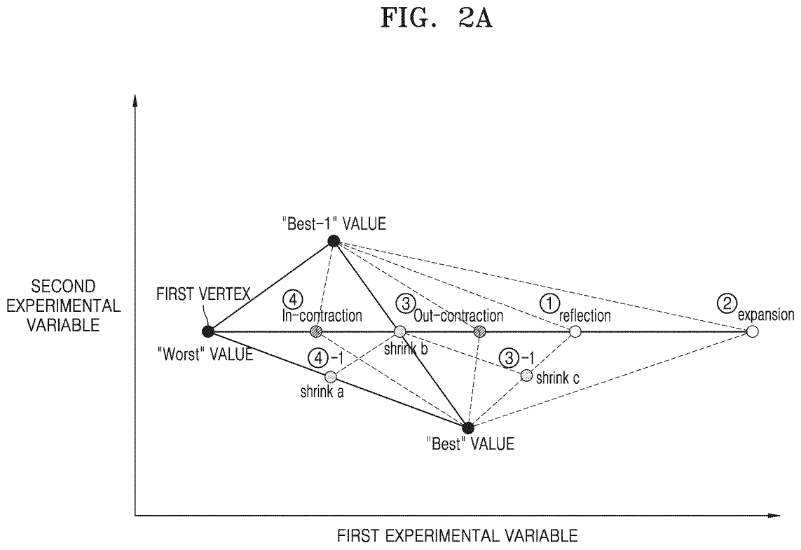

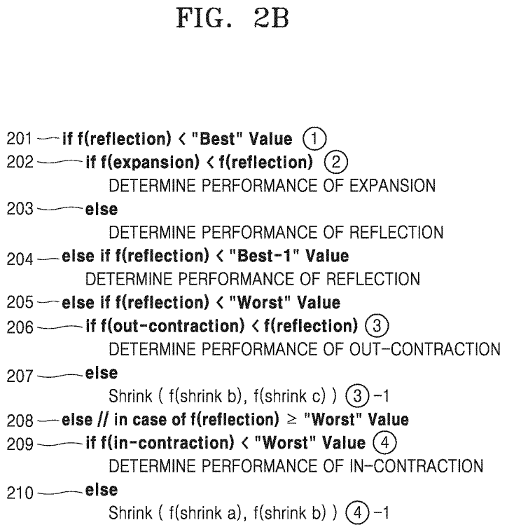

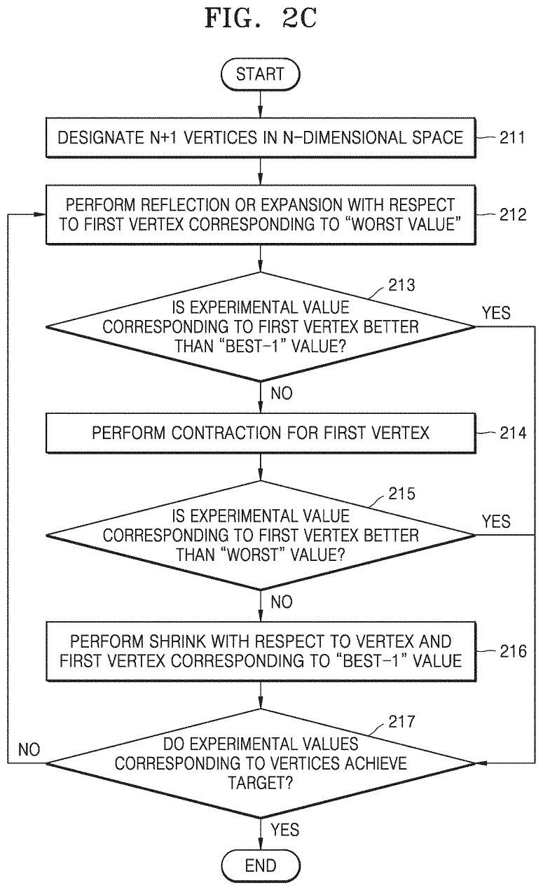

FIGS. 2A to 2C are diagrams showing a method of searching for a synthesis condition according to an embodiment.

FIG. 2A is a diagram illustrating an N-dimensional space according to an embodiment.

In an embodiment, the synthesis condition searching system 100 may move vertices in the N-dimensional space to search for vertices in the N-dimensional space corresponding to a synthesis condition which is an optimal experimental condition. Here, N is a natural number.

The N-dimensional space includes N axes, and each of the N axes may correspond to different experimental variables, respectively. Vertices shown in the N-dimensional space may have experiment conditions corresponding to respective locations. In one embodiment, for example, vertices may have values for each of the N experimental variables corresponding to coordinates in the N-dimensional space.

The controller 110 may designate N+1 vertices separated from each other in the N-dimensional space. The controller 110 may designate the N+1 vertices at a location corresponding to a system setting or a user's setting, or designate vertices at an arbitrary location.

The experiment unit 120 may perform an experiment on each of the N+1 vertices and output experimental values based on an experiment condition corresponding to each of the N+1 vertices. The experiment unit 120 may transmit the experimental values for each of the N+1 vertices to the controller 110 or the search unit 130. Hereinafter, a source for the experimental values will be omitted for convenience of description, but it would be understood that all experimental values are output from the experiment unit 120.

The search unit 130 may determine a first vertex based on the experimental values. The search unit 130 may determine a vertex corresponding to an experimental value having the greatest difference from a target value among first experimental values as the first vertex. In one embodiment, for example, the first vertex may be a vertex corresponding to a worst experimental value among experimental values.

The search unit 130 may move the first vertex to an opposite side of the N−1 dimensional simplex based on the center point of the N−1 dimensional simplex formed by the remaining vertices. An N−1 dimensional simplex refers to a polygon including N points, for example, a one-dimensional simplex corresponding to two points may correspond to a line segment, and a two-dimensional simplex corresponding to three points may correspond to a triangle. In the case of a one-dimensional simplex, the search unit 130 may move the first vertex to the opposite side of the center point based on the center point of the line segment. In the case of a two-dimensional simplex, the search unit 130 may move the first vertex to the opposite side of the center of gravity based on the center of gravity of the triangle. Hereinafter, an operation in which the search unit 130 moves the first vertex to the opposite side of the N−1 dimensional simplex will be referred to as a reflection. The search unit 130 may perform an expansion, a contraction or a shrink, for example, in addition to the reflection, which will be described below.

Referring to FIG. 2A, a two-dimensional space including two axes is shown. Each of the axes corresponds to a first experiment variable and a second experiment variable.

In the embodiment shown in FIG. 2A, the controller 110 may designate three vertices in a two-dimensional space. Experimental values corresponding to the three vertices may correspond to a “Best” value, a “Best−1” value, and a “Worst” value, respectively. The “Best” value is the closest experimental value to a target value and is the best experimental value, the “Best−1” value is the second closest experimental value to the target value, and the “Worst” value is an experimental value having the greatest difference from the target value and is the worst experimental value.

The search unit 130 may determine a vertex corresponding to the “Worst” value as the first vertex. The search unit 130 may perform a reflection in which the first vertex is moved to the opposite side of the center point based on the center point of a line segment including vertices corresponding to the “Best” value and the “Best−1” value.

When an experimental value corresponding to the first vertex \textcircled{1} on which the reflection is performed is better than the “Best” value, the search unit 130 may perform an expansion in which the first vertex \textcircled{1} is further moved along a path of the reflection. However, when an experimental value corresponding to the first vertex \textcircled{2} on which the expansion is performed is not better than the experimental value corresponding to the first vertex \textcircled{1} on which the reflection was performed, the search unit 130 may move the first vertex \textcircled{2} to the location of the first vertex \textcircled{1} on which the reflection is performed.

The search unit 130 may perform a contraction when an experimental value corresponding to the first vertex \textcircled{1} on which the reflection is performed is not better than the value “Best−1”. The contract may include an out-contraction and an in-contraction. When an experimental value corresponding to the first vertex \textcircled{1} is between the “Best−1” value and the “Worst” value, the search unit 130 may perform an out-contraction by which the first vertex \textcircled{1} is moved between the center point of the line segment and the first vertex \textcircled{1} on a path of the reflection. When an experimental value corresponding to the first vertex \textcircled{1} is not better than the “Worst” value, the search unit 130 may perform an in-contraction by which the first vertex \textcircled{1} is moved between the center point of the line segment and the first vertex before a reflection is performed on the reflection path.

When an experimental value corresponding to the first vertex \textcircled{3} or \textcircled{4} on which the contraction is performed is not better than the “Worst” value, the search unit 130 may perform a shrink. The search unit 130 may perform a shrink by which the first vertex \textcircled{3} on which the out-contraction is performed is moved to a location \textcircled{3}−1 between the first vertex \textcircled{1} on which the reflection is performed and a vertex corresponding to the “Best” value, and a vertex corresponding to the “Best−1” value is moved to the center point of the line segment. The search unit 130 may perform a shrink by which the first vertex \textcircled{4} on which the in-contraction is performed is moved to a location \textcircled{4}−1 between the first vertex before a reflection and a vertex corresponding to the “Best” value, and a vertex corresponding to the “Best−1””value is moved to the center point of the line segment.

The search unit 130 may determine the performance of a reflection when an experimental value corresponding to the first vertex \textcircled{1} on which the reflection is performed is between the “Best” value and the “Best−1” value. In this case, the search unit 130 may newly determine a vertex that has previously corresponded to the “Best−1” value as the first vertex, and again may perform a reflection on the newly determined first vertex.

In such an embodiment, when the expansion, contraction, or shrink is completed, the search unit 130 may newly determine a first vertex based on experimental values corresponding to the moved vertices. The search unit 130 may perform the reflection on the newly determined first vertex again.

The search unit 130 may repeat the process of moving the vertices until the final vertex is determined by the controller 110.

Distances of moving the vertices by the search unit 130 may be determined in consideration of a weight according to a system setting.

The controller 110 may determine a final vertex based on experimental values corresponding to the moved vertices. The controller 110 may determine a vertex having the smallest difference between the corresponding experimental value and the target value among the moved vertices as the final vertex.

In one embodiment, for example, the controller 110 may allow the search unit 130 to repeat the operation of moving the vertices until an experimental value that achieves a target value is searched among experimental values corresponding to the vertices. When an experimental value that achieves a target value is searched, the controller 110 may determine a vertex corresponding to the experimental value as a final vertex and stop the operation of the search unit 130.

In one embodiment, for example, when an experimental value having a difference from the target value of less than or equal to a preset value is searched, the controller 110 may determine a vertex corresponding to the experiment value as a final vertex and stop the operation of the search unit 130. Alternatively, when the process of moving the vertices is performed as many as a predetermined number of times, the controller 110 may determine a final vertex based on the experimental values corresponding to the last moved vertices, and stop the operation of the search unit 130. Alternatively, when a difference between the experimental values corresponding to the moved vertices is less than or equal to a preset value, the controller 110 may determine a final vertex, and stop the operation of the search unit 130.

The controller 110 may determine the experiment condition of the final vertex as the synthesis condition. In one embodiment, for example, the controller 110 may determine values for each of the experimental variables having the final vertex as a synthesis condition which is an optimal experimental condition.

FIG. 2B is an algorithm showing a method of searching for a synthesis condition according to an embodiment.

In the embodiment shown in FIG. 2B, it is set that the less the experimental value is, the closer to the target value. In one embodiment, for example, when a certain experimental value is less than the “Best” value, the certain experimental value may be interpreted as being a better experimental value than the “Best” value. However, with regards to whether the experimental value is closer to a target value as the experiment value is smaller, or whether the experimental value is closer to the target value as the experiment value is greater may be determined differently according to the setting of the synthesis condition searching system 100.

In line 201, when the experimental value corresponding to the first vertex \textcircled{1} on which the reflection is performed is less than the “Best” value, the search unit 130 may perform an expansion.

In line 202, when an experimental value corresponding to the first vertex \textcircled{2} on which the expansion is performed is less than an experimental value corresponding to the first vertex \textcircled{1} on which the reflection is performed, the search unit 130 may perform an expansion.

In line 203, when an experimental value corresponding to the first vertex \textcircled{2} on which the expansion is performed is equal to or greater than an experimental value corresponding to the first vertex \textcircled{1} on which the reflection is performed, the search unit 130 may move the first vertex \textcircled{2} again to the location of the first vertex \textcircled{1} on which the reflection is performed. In this case, the search unit 130 may perform a reflection.

In line 204, when an experimental value corresponding to the first vertex \textcircled{1} on which the reflection is performed is equal to or greater than the “Best” value and less than the “Best−1” value, the search unit 130 may perform the reflection.

In line 205, when an experimental value corresponding to the first vertex \textcircled{1} on which the reflection is performed is equal to or greater than the “Best−1” value and less than the “Worst” value, the search unit 130 may perform an out-contraction.

In line 206, when an experimental value corresponding to the first vertex \textcircled{3} on which an out-contraction is performed is less than an experimental value corresponding to the first vertex \textcircled{1} on which the reflection is performed, the search unit 130 may perform the out-contraction.

In line 207, when an experimental value corresponding to the first vertex \textcircled{3} on which an out-contraction is performed is equal to or greater than an experimental value corresponding to the first vertex \textcircled{1} on which a reflection is performed, the search unit 130 may perform a shrink.

In line 208, when an experimental value corresponding to the first vertex \textcircled{1} on which the reflection is performed is equal to or greater than the “Worst” value, the search unit 130 may perform an in-contraction.

In line 209, when an experimental value corresponding to the first vertex \textcircled{4} on which the in-contraction is performed is less than the “Worst” value, the search unit 130 may perform an in-contraction.

In line 210, when an experimental value corresponding to the first vertex \textcircled{4} on which the in-contraction is performed is equal to or greater than the “Worst” value, the search unit 130 may perform a shrink.

The experiment unit 120 may re-output experimental values corresponding to the vertices moved along the line 202, line 203, line 204, line 206, line 207, line 209, and line 210. The search unit 130 may newly determine vertices corresponding to the “Best” value, the “Best−1” value, and the “Worst” value based on the re-output experimental values, and newly determine a first vertex. The search unit 130 may perform again from line 201 based on the moved vertices.

FIG. 2C is a flowchart showing a method of searching for a synthesis condition according to an embodiment.

Referring to FIG. 2C, an embodiment of the method of searching for a synthesis condition includes operations that are sequentially processed by the synthesis condition searching system 100 shown in FIG. 1. Accordingly, any repetitive detailed description of the same or like elements as those of the synthesis condition searching system 100 described above with reference to FIG. 1 will be omitted.

In operation 211, the synthesis condition searching system 100 may designate N+1 vertices in an N-dimensional space.

In operation 212, the synthesis condition searching system 100 may perform a reflection or an expansion on the first vertex corresponding to the “Worst” value. In one embodiment, for example, the synthesis condition searching system 100 may perform operation 213 without performing the expansion when the performance of a reflection is determined, or may perform operation 213 when the performance of an expansion is determined.

In operation 213, the synthesis condition searching system 100 may compare an experimental value corresponding to the first vertex with the “Best−1” value. The synthesis condition searching system 100 may perform operation 214 when an experimental value corresponding to the first vertex is not better than the “Best−1” value.

In operation 214, the synthesis condition searching system 100 may perform a contraction on the first vertex.

In operation 215, the synthesis condition searching system 100 may compare an experimental value corresponding to the first vertex with the “Worst” value. The synthesis condition searching system 100 may perform operation 216 when an experimental value corresponding to the first vertex is not better than the “Worst” value.

In operation 216, the synthesis condition searching system 100 may perform shrink on a vertex and the first vertex corresponding to the “Best−1” value.

In operation 213, when the experimental value corresponding to the first vertex is better than the “Best−1” value, and in operation 215, when the experimental value corresponding to the first vertex is better than the “Worst” value or after performing operation 216, the synthesis condition searching system 100 may perform operation 217.

In operation 217, the synthesis condition searching system 100 may determine whether the experimental values corresponding to the vertices achieve a target or not. The synthesis condition searching system 100 may output the experimental values when the experimental values achieve the target, and output the experimental values corresponding to the moved vertices when the experimental values have not achieved the target, and then, perform operation 212 again.

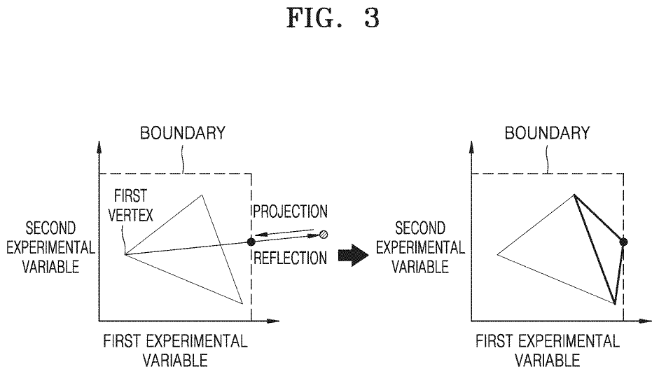

FIG. 3 is a diagram showing a method of performing a projection according to an embodiment.

There may be limitations in experimental conditions. In one embodiment, for example, since there is a physical limit of the experiment unit 120 or a chemical limit of a substance to be synthesized, there may be certain limits on experimental variables included in the experiment conditions. In an embodiment where experimental variables are synthesis temperature and synthesis time, there may be a limit temperature and a limit time in which an experiment is possible due to a physical limit of the experiment unit 120 or a chemical limit of a substance. Limit values for these experimental variables are shown in an N-dimensional space as a boundary of the N-dimensional space.

When the first vertex is moved outside a predetermined boundary of the N-dimensional space by the search unit 130, the search unit 130 may move again the first vertex to a location where a movement path of the first vertex and the boundary cross. The first vertex may be moved outside the boundary as a reflection or an expansion is performed. In this case, the search unit 130 may move again the first vertex to a location where a reflection path and the boundary cross. Hereinafter, an operation in which the search unit 130 moves again the first vertex to a location where the movement path and the boundary of the first vertex cross is referred to as a projection.

The search unit 130 may perform a contraction, etc. based on the experimental value of the first vertex on which the projection is performed, or may newly determine a first vertex and perform the reflection again. In one embodiment, for example, after performing a projection after operation 212 of FIG. 2C, the search unit 130 may perform operation 213.

In an embodiment, the synthesis condition searching system 100 may prevent the experiment condition from exceeding a limit by performing the projection.

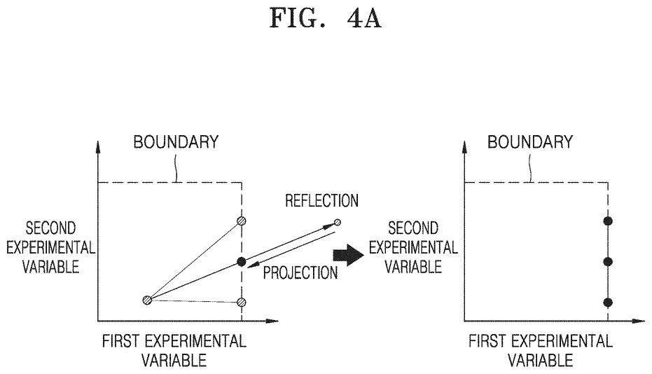

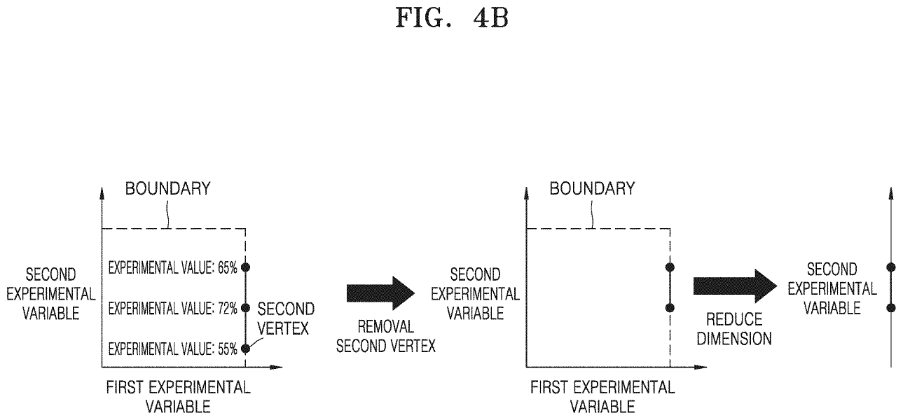

FIGS. 4A and 4B are diagrams showing a method of reducing a dimension of an N-dimensional space according to an embodiment.

Referring to FIG. 4A, in an embodiment, all of the vertices may be located on the boundary when the projection is performed.

Referring to FIG. 4B, when all of the vertices are located on the boundary, the search unit 130 may remove a second vertex and reduce the dimension of the N-dimensional space.

After performing the projection, when all of the vertices are located on the boundary, the search unit 130 may determine a second vertex based on experimental values corresponding to the vertices located on the boundary. The search unit 130 may determine a vertex having the greatest difference between the corresponding experimental value and the target value among vertices located on the boundary as a second vertex. In one embodiment, for example, the second vertex may be a vertex corresponding to an experimental value having the worst result among experimental values.

After removing the second vertex, the search unit 130 may reduce the dimension of the N-dimensional space to an N−1 dimensional space. The search unit 130 may newly determine a first vertex based on the experimental values corresponding to the N vertices in the N−1 dimensional space and perform a reflection again.

In an embodiment, as shown in FIG. 4B, experimental values corresponding to three vertices shown in a two-dimensional space may correspond to yield. Since a target value may be 100%, the yield may be closer to the target value as the experimental value increases. Accordingly, the search unit 130 may determine a vertex corresponding to 55% of the corresponding experimental value as the second vertex. The search unit 130 may reduce the number of vertices from 3 to 2 by removing the second vertices and reduce the dimension of the two-dimensional (“2D”) space to a one-dimensional (“1D”) space. The search unit 130 may determine a vertex corresponding to 65% of the corresponding experimental value among remaining two vertices in the 1D space as the first vertex, and may perform from the reflection again.

In one embodiment, for example, the search unit 130 may perform operation 212 after removing the second vertex after operation 217 of FIG. 2C and reducing the dimension of the N-dimensional space.

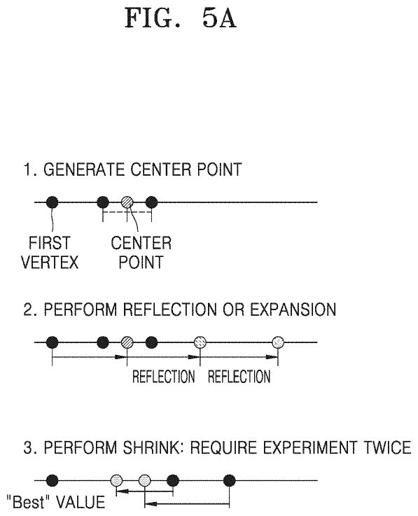

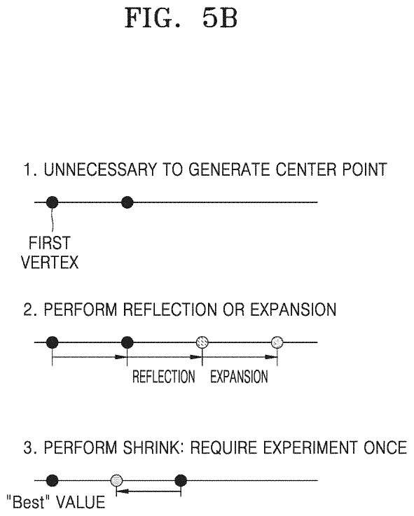

FIGS. 5A and 5B are diagrams showing a result of reducing a dimension of an N-dimensional space according to an embodiment. Referring to FIGS. 5A and 5B, all of the vertices may be located on a boundary.

FIG. 5A is a diagram for a case in which a second vertex is not removed.

In FIG. 5A, one axis is omitted for convenience of illustration and description, but FIG. 5A shows three vertices in a 2D space including two axes. In a case shown in FIG. 5A, the search unit 130 may generate a center point of a 2D simplex corresponding to remaining two vertices to perform a reflection on the first vertex. Thereafter, when the search unit 130 performs a shrink, the two vertices may be moved. In this case, the experiment unit 120 may perform the experiment twice to output experimental values for the two moved vertices.

FIG. 5B is a diagram for a case in which the second vertex is removed.

FIG. 5B shows an embodiment where the dimension of a 2D space is reduced to one dimension, a 1D includes one axis, and the number of vertices is reduced from three to two. In an embodiment shown in FIG. 5B, since the N−1 dimensional simplex corresponds to a 1-dimensional point, a center point is not generated or determined to perform reflection on the first vertex. Thereafter, when the search unit 130 performs a shrink, one vertex may be moved. In such an embodiment, the experiment unit 120 may perform an experiment once to output an experimental value with respect to one moved vertex.

Compared with the case shown in FIG. 5A, in an embodiment of the invention, as shown in FIG. 5B, a process of generating a center point by the search unit 130 is omitted, the number of vertices moved to perform the shrink is reduced, and the number of experiment times performed by the experiment unit 120 is reduced. In such an embodiment, the operation time and the number of operations of the synthesis condition searching system 100 for moving the vertices and outputting an experimental value may be reduced by removing the second vertex and reducing the dimension of the N-dimensional space.

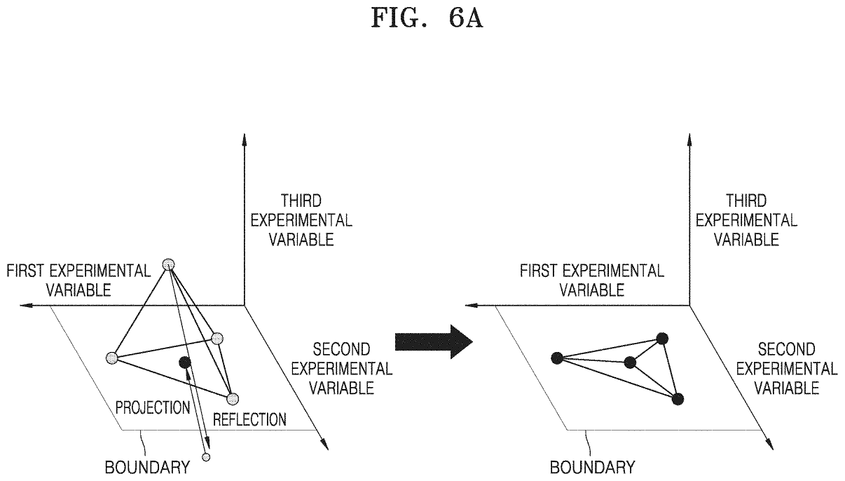

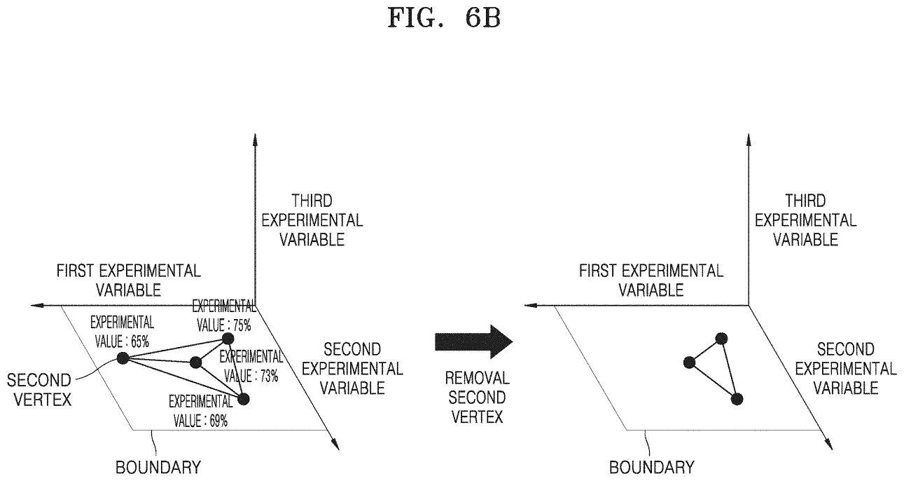

FIGS. 6A and 6B are diagrams showing a method of reducing a dimension of an N-dimensional space according to an alternative embodiment.

Referring to FIG. 6A, as a projection is performed, all of the vertices may be located on a boundary.

Referring to FIG. 6B, when all of the vertices are located on the boundary, the search unit 130 may remove the second vertex and reduce the dimension of the N-dimensional space.

In an embodiment shown in FIG. 6B, experimental values corresponding to four vertices shown in a three-dimensional (“3D”) space may correspond to yield. Since a target value may be 100%, the yield may be closer to the target value as the experimental value increases. Accordingly, the search unit 130 may determine a vertex corresponding to 65% of the corresponding experimental value as a second vertex. The search unit 130 may reduce the number of vertices from 4 to 3 and reduce the dimension of the 3D space to 2D by removing the second vertex. The search unit 130 may determine a vertex corresponding to 69% of the corresponding experimental value among remaining 3 vertices in the 2D space as the first vertex, and perform from the reflection again.

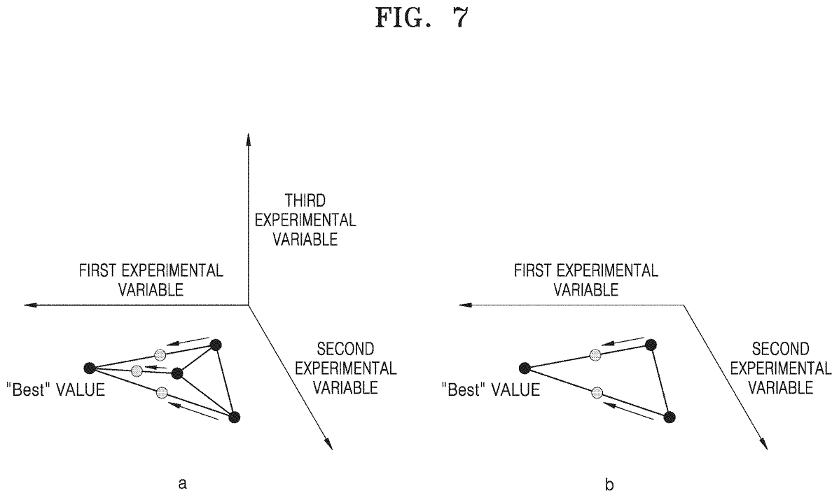

FIG. 7 is a diagram showing a result of reducing a dimension of an N-dimensional space according to an alternative embodiment.

Referring to FIG. 7, all vertices may be located on a boundary.

In FIG. 7, (a) is a diagram showing a case in which the second vertex is not removed.

The case shown in (a) of FIG. 7 is a case in which N+1 vertices are shown in an N-dimensional space including N axes. In the embodiment shown in (a) of FIG. 7, N vertices may be moved by performing a shrink by the search unit 130. In this case, the experiment unit 120 may perform the experiment N times to output experimental values with respect to the moved N vertices.

In FIG. 7, (b) is a diagram for a case in which the second vertex is removed.

The case shown in (b) of FIG. 7 is a case in which the dimension of the N-dimensional space is reduced to N−1 dimension, the N−1 dimensional space includes N−1 axes, and the number of vertices is reduced from N+1 to N according to an embodiment of the invention. In the case shown in (b) of FIG. 7, N−1 vertices may be moved by performing a shrink by the search unit 130. In this case, the experiment unit 120 may perform the experiment N−1 times to output experimental values with respect to the moved N−1 vertices.

Compared with the case shown in (a) of FIG. 7, the number of vertices in the case shown in (b) of FIG. 7 to be moved by the search unit 130 to perform a shrink is reduced, and the number of experiment times performed by the experiment unit 120 is reduced. Accordingly, in an embodiment of the invention, the operation time and the number of operations of the synthesis condition searching system 100 for moving the vertices and outputting an experimental value may be reduced by removing the second vertex and reducing the dimension of the N-dimensional space.

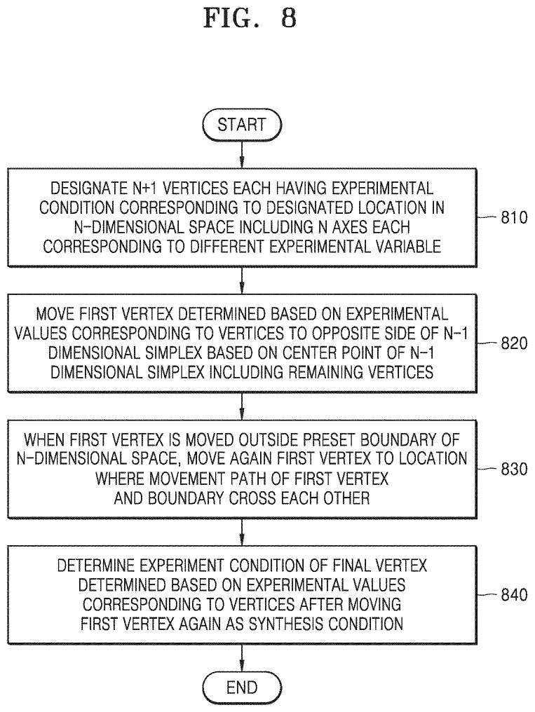

FIG. 8 is a flowchart of a method of searching for a synthesis condition according to an embodiment.

Referring to FIG. 8, an embodiment of the method of searching for a synthesis condition includes operations processed in a time series or sequentially performed in the synthesis condition searching system 100 shown in FIG. 1. Accordingly, the method of searching for a synthesis condition of FIG. 8 may be performed by the synthesis condition searching system 100 described above with reference to FIGS. 1 to 7, and any repetitive detailed description thereof will be omitted.

In operation 810, the synthesis condition searching system 100 may designate N+1 vertices separated from each other, where each of the N+1 vertices has an experimental condition corresponding to a designated location in an N-dimensional space including N axes corresponding to different experimental variables.

In operation 820, the synthesis condition searching system 100 may move a first vertex determined based on experimental values corresponding to the vertices to an opposite side of the N−1 dimensional simplex based on the center point of the N−1 dimensional simplex corresponding to remaining N vertices. Operation 820 may correspond to a reflection operation.

The synthesis condition searching system 100 may determine a vertex corresponding to an experimental value having the greatest difference from a target value among experimental values as a first vertex.

In operation 830, when the first vertex is moved outside a preset boundary of the N-dimensional space, the synthesis condition searching system 100 may move again the first vertex to a location where a movement path of the first vertex and the boundary cross each other. Operation 830 may correspond to a projection operation.

After operation 830, when all of the vertices are located on the boundary, the synthesis condition searching system 100 may remove the second vertex determined based on experimental values corresponding to the vertices located on the boundary.

The synthesis condition searching system 100 may determine a vertex having the greatest difference between a corresponding experimental value and a target value among vertices located on the boundary as a second vertex.

The synthesis condition searching system 100 may reduce the N-dimensional space to an N−1 dimension after removing the second vertex.

The synthesis condition searching system 100 may perform again from operation 820 with respect to the N vertices except for the second vertex.

In operation 840, the synthesis condition searching system 100 may determine an experiment condition of a final vertex determined based on experimental values corresponding to vertices after moving the first vertex again as a synthesis condition.

The synthesis condition searching system 100 may determine a vertex having the smallest difference between a corresponding experimental value and a target value among vertices after operation 830 as the final vertex.

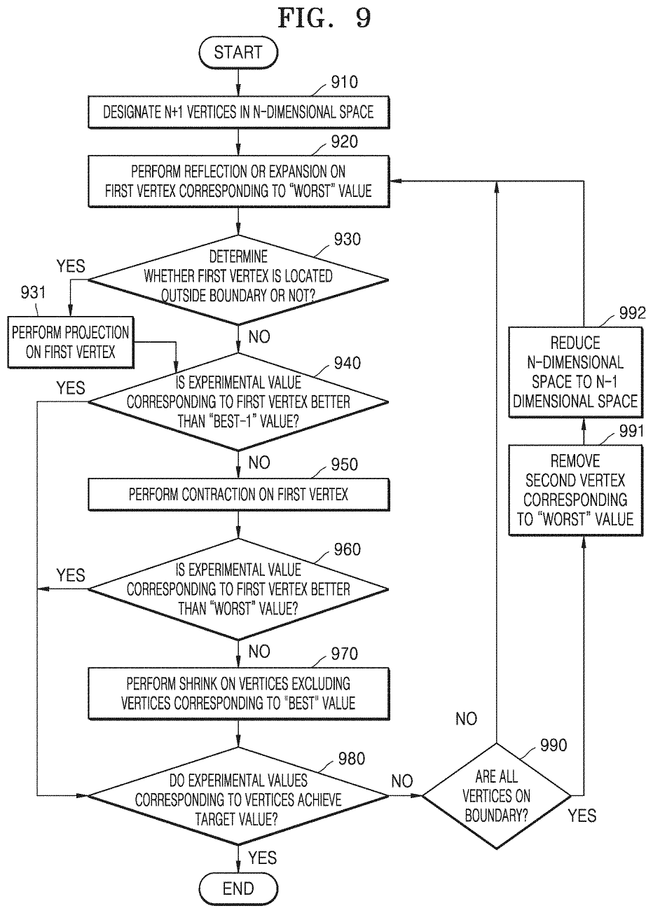

FIG. 9 is a flowchart of a method of searching for a synthesis condition according to an alternative embodiment.

Referring to FIG. 8, the method of searching for a synthesis condition includes operations processed in a time series by the synthesis condition searching system 100 shown in FIG. 1. Accordingly, any repetitive detailed description of the same or like elements as those of the synthesis condition searching system 100 described above with reference to FIGS. 1 to 8 will be omitted.

In operation 910, the synthesis condition searching system 100 may designate N+1 vertices in an N-dimensional space.

In operation 920, the synthesis condition searching system 100 may perform a reflection or an expansion on the first vertex corresponding to the “Worst” value. In one embodiment, for example, when the performance of a reflection is determined, the synthesis condition searching system 100 may perform operation 930 without performing an expansion, or may perform operation 930 when the performance of the expansion is determined.

In operation 930, the synthesis condition searching system 100 may determine whether the first vertex is located outside a boundary or not. The synthesis condition searching system 100 may perform operation 931 when the first vertex is located outside the boundary. The synthesis condition searching system 100 may perform operation 940 when the first vertex is not located outside the boundary.

In operation 931, the synthesis condition searching system 100 may perform a projection on the first vertex.

In operation 940, the synthesis condition searching system 100 may compare the experimental value corresponding to the first vertex with the “Best−1” value. The synthesis condition searching system 100 may perform operation 950 when the experimental value corresponding to the first vertex is not better than the “Best−1” value.

In operation 950, the synthesis condition searching system 100 may perform a contraction on the first vertex.

In operation 960, the synthesis condition searching system 100 may compare the experimental value corresponding to the first vertex with the “Worst” value. The synthesis condition searching system 100 may perform operation 970 when the experimental value corresponding to the first vertex is not better than the “Worst” value.

In operation 970, the synthesis condition searching system 100 may perform a shrink on vertices excluding vertices corresponding to the “Best” value.

When the experimental value corresponding to the first vertex in operation 940 is better than the “Best−1” value, when the experimental value corresponding to the first vertex in operation 960 is better than the “Worst” value, or after performing operation 970, the synthesis condition searching system 100 may perform operation 980.

In operation 980, the synthesis condition searching system 100 may determine whether the experimental values corresponding to the vertices achieve a target value or not. The synthesis condition searching system 100 may output the experimental values when the experimental values achieve the target, and perform operation 990 when the experimental values are not achieved.

In operation 990, the synthesis condition searching system 100 may determine whether all of the vertices are located on the boundary or not. When all of the vertices are located on the boundary in operation 990, the synthesis condition searching system 100 may perform operation 991 and operation 992.

In operation 991, the synthesis condition searching system 100 may remove the second vertex corresponding to the “Worst” value. In operation 991, the number of vertices may be reduced from N+1 to N.

In operation 992, the synthesis condition searching system 100 may reduce the dimension of the N-dimensional space to an N−1 dimensional space.

When at least one vertex is not located on the boundary in operation 990 or after performing operation 992, the synthesis condition searching system 100 may output experimental values corresponding to the changed vertices and perform operation 920 again.

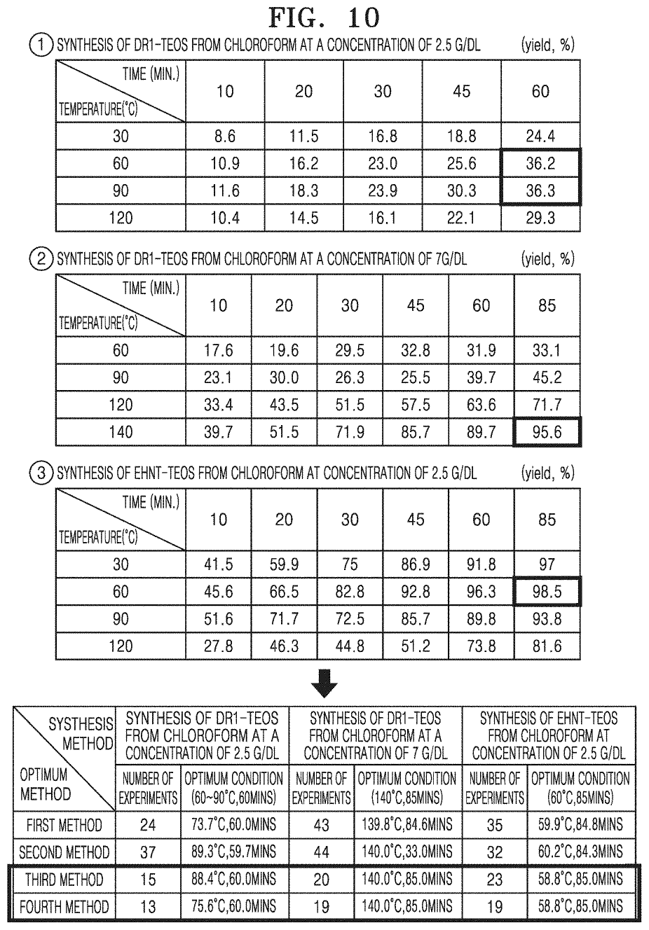

FIG. 10 is a diagram showing synthesis condition search results according to various embodiments.

An upper part of FIG. 10 shows results of experiments performed in advance under various experimental conditions with respect to an experiment for synthesizing Disperse Red 1-Tetraethyl orthosilicate (“DR1-TEOS”) from chloroform at a concentration of 2.5 g/dl, an experiment for synthesizing DR1-TEOS from chloroform at a concentration of 7 g/dl, and an experiment for synthesizing 2-[4′-(N-Ethyl-N-2-hydroxyethyl)-amino-phenylazo]-5-nitrothiazole-Tetraethyl orthosilicate (“EHNT-TEOS”) from chloroform at a concentration of 2.5 g/dl. A lower part of FIG. 10 shows results output when experiments are performed according to various embodiments.

The experiments are conducted under experimental conditions including two experimental variables, synthesis time and synthesis temperature. According to the results of experiments performed in advance, in the experiment of synthesizing DR1-TEOS from chloroform at a concentration of 2.5 g/dl, an optimum experimental result is outputted at a time of 60 minutes and a temperature in a range from about 60° C. to about 90° C. Also, optimum experimental results are outputted at a time of 85 minutes and a temperature of about 140° C. in the experiment for synthesizing DR1-TEOS from chloroform at a concentration of 7 g/dl, and at a time of 85 minutes and a temperature of about 60° C. in the experiment for synthesizing EHNT-TEOS from chloroform at a concentration of 2.5 g/dl.

In various embodiments, a search for a synthesis condition is performed by using three vertices in a 2D space for experiments. The search for the synthesis condition according to various embodiments is performed until a difference between the “Best” value and the “Worst” value among experimental values corresponding to the moved vertices is less than a preset value. Various embodiments may include first to fourth methods.

The first method is a method of searching for a synthesis condition by performing reflection, expansion, contraction, and shrink, and may include the embodiment shown in FIGS. 2A to 2C. However, in the case when a vertex is located outside the boundary in the first method, a preset experimental value is assigned to an experimental value corresponding to the vertex outside the boundary. The preset experimental value is a value having the greatest difference from a target value, for example, when the target value is 100%, the preset experimental value may be 0%.

The second method is a method of searching for a synthesis condition by performing only reflection and shrink.

The third method is a method of searching for a synthesis condition by performing reflection, expansion, contract, shrink, and projection, and is a method to which an embodiment of performing a projection is added to the embodiment of FIGS. 2A to 2C.

The fourth method is a method to which an embodiment of removing a second vertex and reducing the dimension of the N-dimensional space is added in addition to the third method.

Referring to the lower part of FIG. 10, in the experiment of synthesizing DR1-TEOS from chloroform at a concentration of 2.5 g/dl, optimum experimental conditions (60 minutes and 60° C. to 90° C.) in all of the first to fourth methods are searched. The number of experiments to search for an optimum experimental condition is recorded the least in the fourth method and the second least in the third method.

In the experiment of synthesizing DR1-TEOS from chloroform at a concentration of 7 g/dl, optimum experimental conditions (i.e., 85 minutes and 140° C.) are searched in the methods except for the second method. The number of experiments to search for optimal experimental conditions is recorded the least in the fourth method and the second lowest in the third method.

In the experiment of synthesizing EHNT-TEOS from chloroform at a concentration of 2.5 g/dl, optimum experimental conditions (i.e., 85 minutes and 60° C.) are searched in all of the first to fourth methods. The number of experiments to search for optimal experimental conditions is recorded the least in the fourth method and the second lowest in the third method.

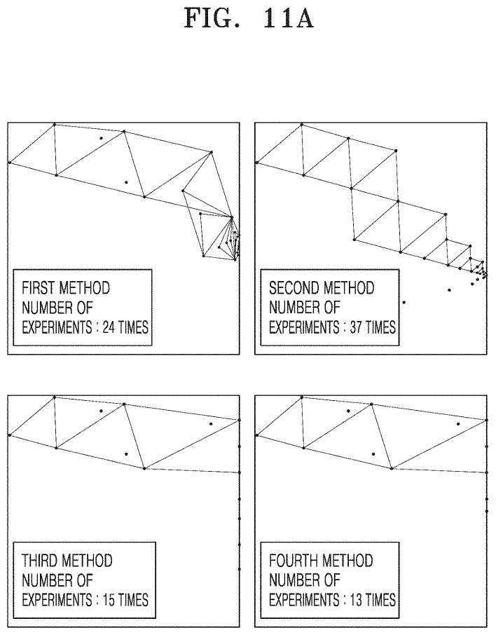

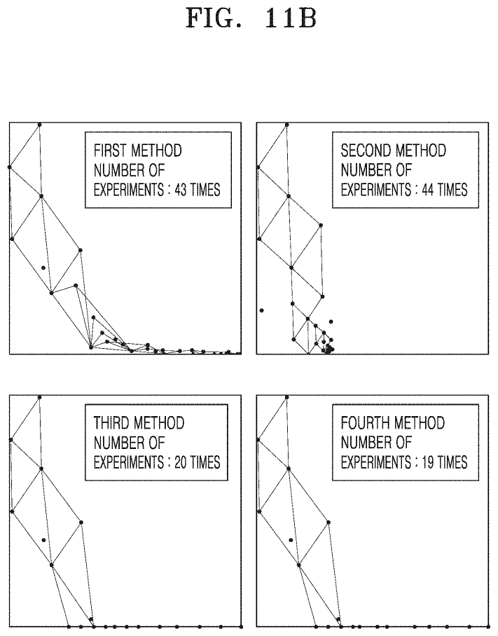

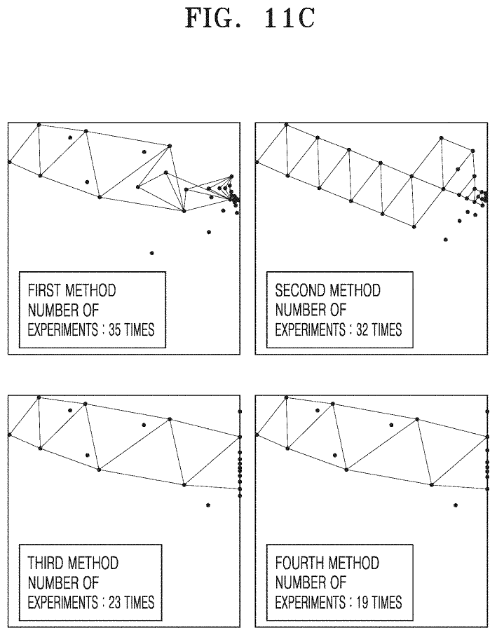

FIGS. 11A to 11C are diagrams illustrating an N-dimensional space according to the experiment of FIG. 10.

Referring to FIGS. 11A to 11C, records of vertices moved according to the first to fourth methods in the N-dimensional space are shown. The vertices are initially assigned to an upper left of the N-dimensional space, and the vertices are gradually moved to the right to search for a synthesis condition. FIG. 11A shows an N-dimensional space with respect to an experiment of synthesizing DR1-TEOS from chloroform at a concentration of 2.5 g/dl, FIG. 11B shows an N-dimensional space with respect to an experiment for synthesizing DR1-TEOS from chloroform at a concentration of 7 g/dl, and FIG. 11C shows an N-dimensional space with respect to an experiment of synthesizing EHNT-TEOS from chloroform at a concentration of 2.5 g/dl.

Referring to FIGS. 11A to 11C, from the moment when all of the vertices are located at a boundary of the N-dimensional space, a movement distance of the vertices in the fourth method is the greatest and the number of movements is the least. Accordingly, the second vertex is removed in the fourth method and the dimension of the N-dimensional space is reduced, and thus, the vertices are moved most efficiently.

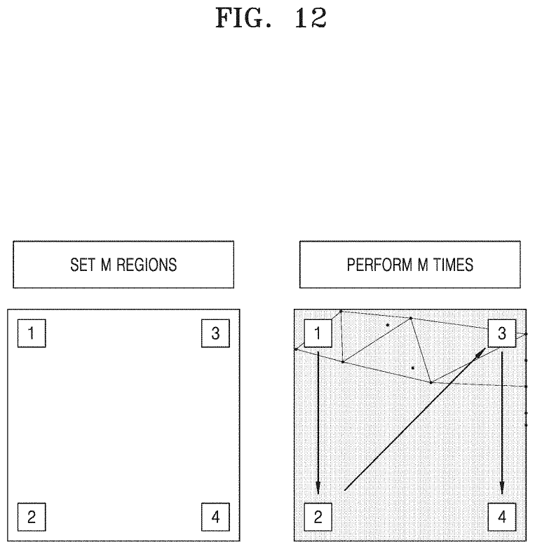

FIG. 12 is a diagram showing an embodiment in which vertices are designated for each of a plurality of regions.

Referring to FIG. 12, M regions are set in an N-dimensional space, and a method of searching for a synthesis condition may be performed with respect to each of the regions.

The controller 110 may set a plurality of regions separated from each other in the N-dimensional space, and designate N+1 vertices in each of the regions. In one embodiment, for example, the controller 110 may designate N+1 vertices, which are different from N+1 vertices designated in an existing region, in a region separated from the existing region in which the N+1 vertices are designated.

After determining a final vertex with respect to vertices designated in the existing region, the synthesis condition searching system 100 may designate vertices in a region separated from the existing region, and perform from the reflection again with respect to the vertices designated in the separated region, and thus, may determine another final vertex. The controller 110 may determine a final vertex for each of the plurality of regions. The controller 110 may determine an experiment condition of a final vertex having the least difference between a corresponding experimental value and a target value among final vertices determined with respect to vertices designated for each of the plurality of regions as the synthesis condition.

The synthesis condition searching system 100 may search for a local optimal as well as a global optimal by determining a synthesis condition after comparing a plurality of final vertices.

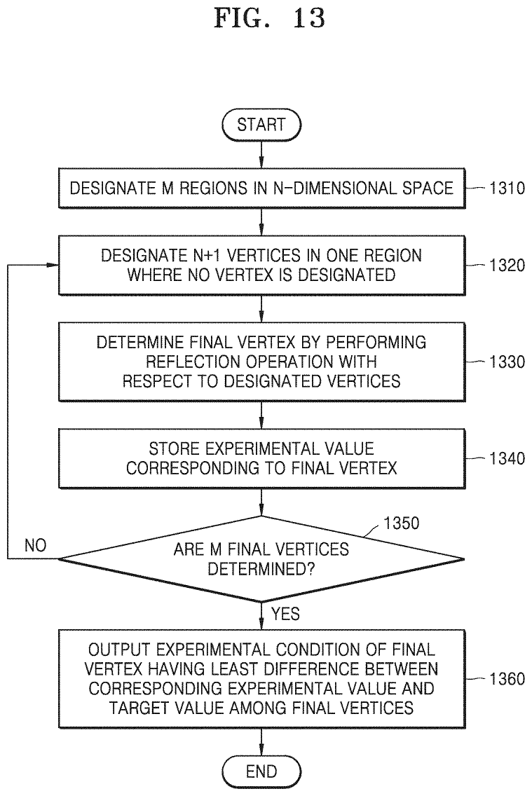

FIG. 13 is a flowchart of a method of searching for a synthesis condition according to the embodiment of FIG. 12.

Referring to FIG. 13, an embodiment of the method of searching for a synthesis condition includes operations processed in time series in the embodiment of FIG. 12.

In operation 1310, the synthesis condition searching system 100 may designate M regions in an N-dimensional space.

In operation 1320, the synthesis condition searching system 100 may designate N+1 vertices in one region where no vertex is designated.

In operation 1330, the synthesis condition searching system 100 may determine a final vertex by performing a reflection operation with respect to the designated vertices.

In operation 1340, the synthesis condition searching system 100 may store an experimental value corresponding to the final vertex.

In operation 1350, the synthesis condition searching system 100 may determine whether M final vertices are determined or not. The synthesis condition searching system 100 may perform operation 1320 when the M final vertices are not determined. The synthesis condition searching system 100 may perform operation 1360 when the M final vertices are determined.

In operation 1360, the synthesis condition searching system 100 may output an experimental condition of a final vertex having the least difference between a corresponding experimental value and a target value among final vertices.

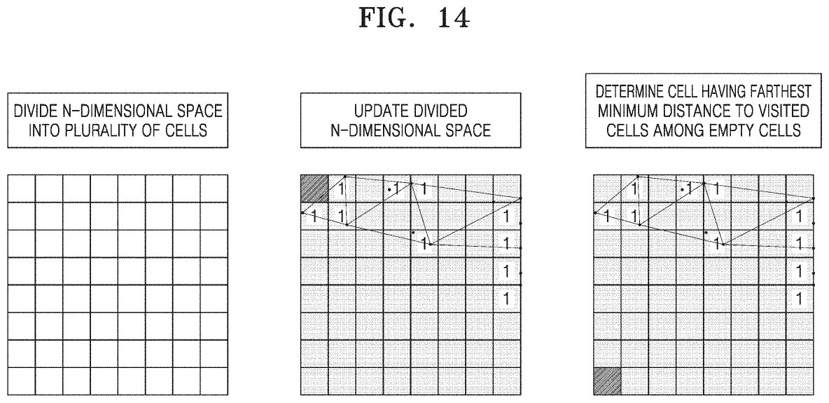

FIG. 14 is a diagram showing another alternative embodiment in which vertices are designated in each of a plurality of regions.

After determining the final vertex with respect to N+1 vertices designated in the existing region, the controller 110 may designate different N+1 vertices in a separated region. The controller 110 may determine the location of the separated region based on the movement record of vertices designated in the existing region.

In one embodiment, for example, the controller 110 may divide the N-dimensional space into a plurality of cells. The controller 110 may update the N-dimensional space based on movement records of the vertices that are moved to determine the final vertices. The controller 110 may update the N-dimensional space by displaying all cells in which the vertices are located. The controller 110 may determine a cell having the farthest minimum distance to the visited cells in which the vertices are located among empty cells in which the vertices are not located. The controller 110 may determine a separated region spaced apart from the existing region based on the determined cell, and may designate N+1 vertices in the separated region.

The controller 110 may determine an experiment condition of a final vertex, in which a difference between a corresponding experimental value and a target value is the least, among final vertices determined with respect to vertices designated for each of the plurality of regions as the synthesis condition. The synthesis condition searching system 100 may search for a global optimal as well as a local optimal by determining a synthesis condition through comparing a plurality of final vertices.

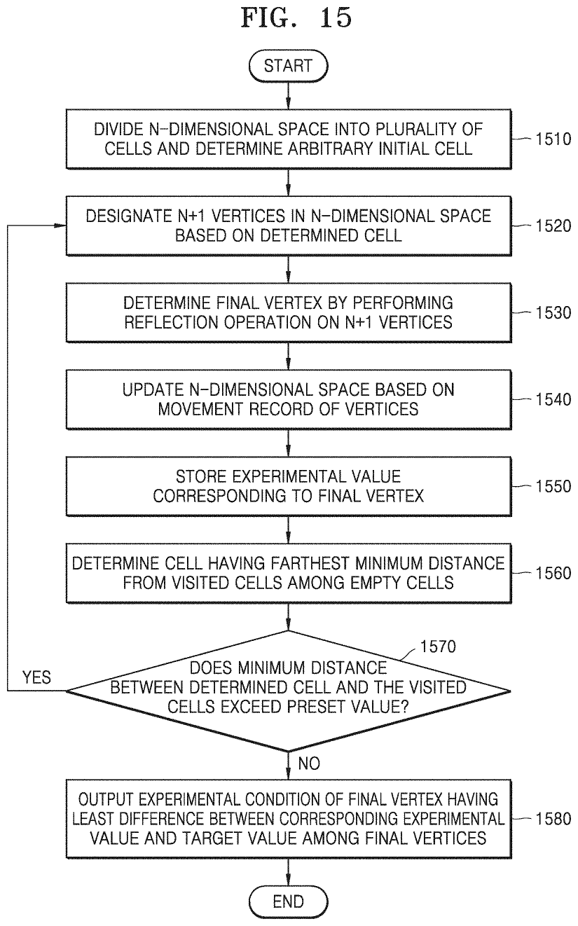

FIG. 15 is a flowchart of a method of searching for a synthesis condition according to the embodiment of FIG. 14.

Referring to FIG. 15, an embodiment of the method of searching for a synthesis condition includes operations processed in time series in the embodiment of FIG. 14.

In operation 1510, the synthesis condition searching system 100 may divide the N-dimensional space into a plurality of cells and determine an arbitrary initial cell.

In operation 1520, the synthesis condition searching system 100 may designate N+1 vertices in the N-dimensional space based on the determined cell.

In operation 1530, the synthesis condition searching system 100 may determine a final vertex by performing a reflection operation on N+1 vertices.

In operation 1540, the synthesis condition searching system 100 may update the N-dimensional space based on the movement record of the vertices.

In operation 1550, the synthesis condition searching system 100 may store an experimental value corresponding to the final vertex.

In operation 1560, the synthesis condition searching system 100 may determine a cell having the farthest minimum distance from visited cells among empty cells.

In operation 1570, the synthesis condition searching system 100 may determine whether the minimum distance between the determined cell and the visited cells exceeds a preset value or not. The synthesis condition searching system 100 may perform operation 1520 when the minimum distance exceeds a preset value. The synthesis condition searching system 100 may perform operation 1580 when the minimum distance is equal to or less than a preset value.

In operation 1580, the synthesis condition searching system 100 may output an experimental condition of a final vertex having the least difference between a corresponding experimental value and a target value among final vertices.

Embodiments of the method for searching a synthesis condition described above with reference to FIGS. 2C, 8, 9, 13, and 15 may be recorded on a non-transitory computer-readable recording medium in which one or more programs including instructions for executing the method are recorded. In such an embodiment, the non-transitory computer-readable recording media include magnetic media, such as hard disks, floppy disks, and magnetic tape, optical media, such as CD-ROMs and DVDs, magneto-optical media, such as floptical disks, and hardware devices specifically configured to store and execute program instructions, such as ROM, RAM, flash memory, etc. In such an embodiment, the program instructions include machine code produced by a compiler as well as high-level language code that may be executed by a computer by using an interpreter, etc.

It should be understood that embodiments described herein should be considered in a descriptive sense only and not for purposes of limitation. The invention should not be construed as being limited to the embodiments set forth herein. Rather, these embodiments are provided so that this disclosure will be thorough and complete and will fully convey the concept of the invention to those skilled in the art. Descriptions of features or aspects within each embodiment should typically be considered as available for other similar features or aspects in other embodiments.

While the invention has been described with reference to embodiments thereof, it will be understood by those of ordinary skill in the art that various changes in form and details may be made therein without departing from the spirit and scope as defined by the following claims.

What is claimed is:

1. A method of searching for a synthesis condition, the method comprising:
designating N+1 vertices separated from each other in an N-dimensional space including N axes, each corresponding to a different experimental variable, wherein each of the N+1 vertices has an experimental condition corresponding to a designated location in the N-dimensional space, and N is a natural number;
performing a reflection operation for moving a first vertex determined based on experimental values corresponding to the N+1 vertices to an opposite side of an N−1 dimensional simplex based on a center point of the N−1 dimensional simplex corresponding to remaining N vertices;
performing a projection operation for moving again the first vertex back to a location where a movement path of the first vertex and a predetermined boundary of the N-dimensional space cross each other when the first vertex is moved outside the predetermined boundary of the N-dimensional space; and
determining an experimental condition of a final vertex determined based on experimental values corresponding to vertices after the projection operation as the synthesis condition.

2. The method of claim 1, further comprising:
after the performing the projection operation, removing a second vertex determined based on experimental values corresponding to vertices located on the predetermined boundary when all of the N+1 vertices are located on the predetermined boundary.

3. The method of claim 2, further comprising:
after the removing the second vertex, reducing the N-dimensional space to an N−1 dimensional space, and
after the reducing the N-dimensional space to the N−1 dimensional space, performing the reflection operation again with respect to N vertices of the N+1 vertices excluding the second vertex.

4. The method of claim 1, wherein the reflection operation comprises determining a vertex corresponding to the experimental value having the greatest difference from a target value among the experimental values as the first vertex.

5. The method of claim 2, wherein the removing the second vertex comprises determining a vertex having the greatest difference between a corresponding experimental value and a target value among the vertices located on the predetermined boundary as the second vertex.

6. The method of claim 1, wherein the determining the synthesis condition comprises determining a vertex having the least difference between a corresponding experimental value and a target value among the vertices after the projection operation as the final vertex.

7. The method of claim 1, further comprising:
designating N+1 vertices different from the N+1 vertices in a separated region from an existing region where the N+1 vertices are designated,
wherein from the reflection operation is performed with respect to the vertices designated in the separated region.

8. The method of claim 7, wherein the determining the synthesis condition comprises determining an experiment condition of a final vertex having the least difference between a corresponding experimental value and a target value among the final vertices determined with respect to the vertices respectively designated in the existing region and the separated region as the synthesis condition.

9. The method of claim 7, further comprising:
designating the different N+1 vertices after determining the synthesis condition,
wherein the designating the different N+1 vertices comprises determining a location of the separated region based on a movement record of the vertices designated in the existing region.

10. A system for searching for a synthesis condition, the system comprising:
a controller which designates N+1 vertices separated from each other in an N-dimensional space including N axes, each corresponding to a different experimental variable, wherein each of the N+1 vertices has an experimental condition corresponding to a designated location in the N-dimensional space, and N is a natural number;
an experiment unit which outputs experimental values corresponding to the N+1 vertices; and
a search unit which determines a first vertex based on the experimental values, and moves the first vertex to an opposite side of an N−1 dimensional simplex based on a center point of the N−1 dimensional simplex corresponding to remaining N vertices,
wherein the search unit moves the first vertex to a location where a movement path of the first vertex and a predetermined boundary of the N-dimensional space cross each other when the first vertex is moved outside the predetermined boundary of the N-dimensional space, and
the controller determines a final vertex based on experimental values corresponding to vertices after moving the first vertex again, and determines an experimental condition of the final vertex as the synthesis condition.

11. The system of claim 10, wherein the search unit determines a second vertex based on experimental values corresponding to the vertices located on the predetermined boundary, when all of the N+1 vertices are located on the predetermined boundary, and removes the second vertex.

12. The system of claim 11, wherein the search unit reduces the N-dimensional space to an N−1 dimensional space, and determines the first vertex based on experimental values corresponding to N vertices excluding the second vertex.

13. The system of claim 10, wherein the search unit determines a vertex corresponding to an experimental value having the greatest difference from a target value among experimental values corresponding to the N+1 vertices as the first vertex.

14. The system of claim 10, wherein the search unit determines a vertex having the greatest difference between a corresponding experimental value and a target value among vertices located on the predetermined boundary as a second vertex when all of the N+1 vertices are located on the predetermined boundary.

15. The system of claim 10, wherein the search unit determines, as the final vertex, a vertex with the least difference between a corresponding experimental value and a target value among the N+1 vertices after moving the first vertex again.

16. The system of claim 10, wherein the controller designates N+1 vertices in a separated region, which are different from the N+1 vertices in an existing region, where the separated region is different from the existing region where the N+1 vertices are designated.

17. The system of claim 16, wherein the controller determines an experiment condition of a final vertex having the least difference between a corresponding experimental value and a target value among the final vertices determined with respect to the vertices designated in each of the existing region and the separated region.

18. The system of claim 16, wherein the controller determines a location of the separated region based on a movement record of vertices designated in the existing region.

19. A recording medium comprising a computer-readable recording medium storing a program for executing the method of claim 1.
